(19) United States
(12) Patent Application Publication
(10) Pub. No.: US 2025/0365508 A1
(43) Pub. Date: Nov. 27, 2025

(54) IMAGE STABILIZING APPARATUS, ITS CONTROL METHOD, OPTICAL APPARATUS, AND STORAGE MEDIUM

(71) Applicant: CANON KABUSHIKI KAISHA, Tokyo (JP)

(72) Inventor: RYUICHIRO YASUDA, Tokyo (JP)

(21) Appl. No.: 19/186,047

(22) Filed: Apr. 22, 2025

(30) Foreign Application Priority Data
May 27, 2024 (JP) 2024-085255

(51) Int. Cl. H04N 23/68

(52) U.S. Cl. CPC H04N 23/683; H04N 23/6812

(57) ABSTRACT

An image stabilizing apparatus includes a first acquiring unit configured to acquire a first shake signal using a first sensor, a second acquiring unit configured to acquire a second shake signal having a larger noise amount in a high-frequency band and a smaller noise amount in a low-frequency band than those of the first shake signal, using a second sensor, and at least one processor that executes instructions to generate a combined image stabilizing signal based on a first signal of the first shake signal, which first signal has a frequency higher than a cutoff frequency and a second signal of the second shake signal, which second signal has a frequency lower than the cutoff frequency, set the cutoff frequency, and change the cutoff frequency according to imaging condition information.

### BACKGROUND

### Technical Field

The present disclosure relates to an image stabilizing apparatus, its control method, an optical system, and a storage medium.

### Description of Related Art

An image pickup apparatus (optical apparatus), such as a digital camera, uses a known technology in which an image sensor such as a CMOS sensor or a part of optical elements in an imaging optical system are moved in a direction orthogonal to the optical axis to correct image blur caused by a shake applied to the image pickup apparatus. Such an image pickup apparatus having an image stabilizing function generally detects a shake applied to the image pickup apparatus using a gyro sensor.

Japanese Patent Application Laid-Open No. 2018-116134 discloses a method of calculating an offset component of a detection signal of a gyro sensor based on a combined signal by a complementary filter of a detection signal of an acceleration or a geomagnetic sensor and a detection signal of the gyro sensor, and subtracting the offset component from the detection signal of the gyro sensor. Japanese Patent Application Laid-Open No. 2018-205551 discloses a method of changing the weight of a combination based on the reliability of a motion vector in combining a motion vector and a gyro sensor using a complementary filter or the like.

In calculating the combined signal using the complementary filter or the like from a low-frequency component of the acceleration or geomagnetic sensor and a high-frequency component of the gyro sensor, the noise characteristic of the combined signal changes according to a cutoff frequency between the low-frequency and high-frequency components. Thus, it is important to properly set the cutoff frequency.

However, Japanese Patent Application Laid-Open No. 2018-116134 does not disclose a method of setting the cutoff frequency. Japanese Patent Application Laid-Open No. 2018-205551 discloses the method of setting the cutoff frequency, but is silent about a method of setting the cutoff frequency in the combination with a sensor other than the motion vector.

### SUMMARY

An image stabilizing apparatus according to one aspect of the present disclosure includes a first acquiring unit configured to acquire a first shake signal using a first sensor, a second acquiring unit configured to acquire a second shake signal having a larger noise amount in a high-frequency band and a smaller noise amount in a low-frequency band than those of the first shake signal, using a second sensor, and at least one processor that executes instructions to generate a combined image stabilizing signal based on a first signal of the first shake signal, which first signal has a frequency higher than a cutoff frequency and a second signal of the second shake signal, which second signal has a frequency lower than the cutoff frequency, set the cutoff frequency, and change the cutoff frequency according to imaging condition information. An optical apparatus having the above image stabilizing apparatus, a control method of the above image stabilizing apparatus, and a storage medium storing a program that causes a computer to execute the above control method also constitutes another aspect of the present disclosure.

Further features of various embodiments of the disclosure will become apparent from the following description of embodiments with reference to the attached drawings.

### BRIEF DESCRIPTION OF THE DRAWINGS

FIG. 1 is a block diagram of an image stabilizing apparatus according to a first embodiment.

FIG. 2 illustrates a relationship between the image pickup apparatus and axial directions in each embodiment.

FIG. 3 is a flowchart illustrating the processing of the image stabilizing apparatus according to the first embodiment.

FIG. 4 illustrates a relationship between a target cutoff frequency and exposure time in the first embodiment.

FIG. 5 illustrates the time progression of the cutoff frequency in the first embodiment.

FIG. 6 is a block diagram of an image stabilizing apparatus according to a second embodiment.

FIG. 7 is a flowchart illustrating the processing of the image stabilizing apparatus according to the second embodiment.

FIG. 8 illustrates the time progression of the cutoff frequency in the second embodiment.

FIG. 9 is a schematic diagram illustrating the frequency characteristic of a complementary filter in each embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of a variety of embodiments according to the present disclosure. The following embodiments do not limit the present disclosure directed to the attached claims. Although the embodiments describe a plurality of features, not all of these features are necessarily required for the present disclosure, and the plurality of features may be combined in an arbitrary manner. Corresponding elements in respective figures will be designated by the same reference numerals, and a duplicate description thereof will be omitted.

### First Embodiment

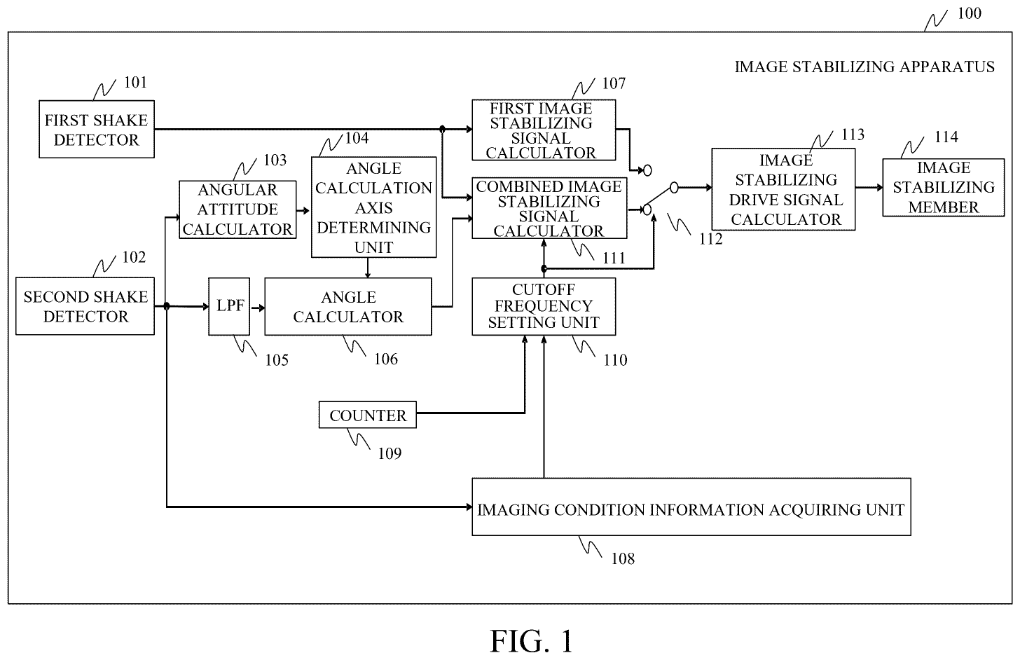

FIG. 1 illustrates the configuration of an image stabilizing apparatus 100 according to a first embodiment of the present disclosure. The image stabilizing apparatus 100 is provided in an optical apparatus such as an image pickup apparatus or a lens apparatus.

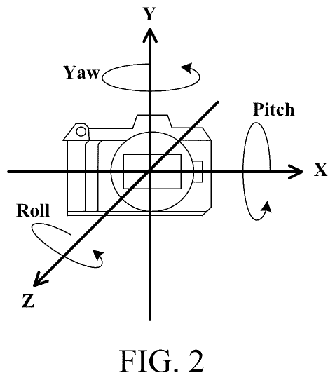

A first shake detector (first acquiring unit) 101 is a gyro sensor configured to detect (acquire) shake in rotation-axis directions (pitch, yaw, and roll directions) around three mutually orthogonal axes, i.e., an X-axis, a Y-axis, and a Z-axis. FIG. 2 illustrates a relationship between the image pickup apparatus and the axial directions. The horizontal direction of the image pickup apparatus is defined as the X-axis, the vertical direction of the image pickup apparatus is defined as the Y-axis, the optical axis direction is defined as the Z-axis, the rotation axis around the X-axis is defined as the pitch axis, the rotation axis around the Y-axis is defined as the yaw axis, and the rotation axis around the Z-axis is defined as the roll axis. The first shake detector 101 detects a first shake signal (angular velocity signal) applied to the image pickup apparatus, and outputs the first shake signal to a first image stabilizing signal calculator (first calculator) 107 and a combined image stabilizing signal calculator (generator) 111.

A second shake detector (second acquiring unit) 102 is at least one of an acceleration sensor and a geomagnetic sensor configured to detect (acquires) shake in three mutually orthogonal axial directions (X-axis, Y-axis, and Z-axis directions). The second shake detector 102 detects a second shake signal (at least one of an acceleration signal and a geomagnetic signal) applied to the image pickup apparatus, and outputs the second shake signal to an angular attitude calculator 103, a low-pass filter (LPF) 105, and an imaging condition information acquiring unit 108. In this embodiment, the second shake signal has a characteristic that a noise amount in the high-frequency band is larger than that of the first shake signal, and a noise amount in the low-frequency band is smaller than that of the first shake signal.

The gyro sensor as the first shake detector 101 is a sensor configured to detect a rotational shake in the state of angular velocity among the shake applied to the image stabilizing apparatus 10, and it is very important to improve the detection accuracy of the gyro sensor. One of the important issues in improving the detection accuracy of the gyro sensor is how to remove the low-frequency noise (offset component) that the gyro sensor has. In a case where the signal of the gyro sensor is used without removing the offset component by integrating an output signal of the gyro sensor and by treating it as an angle, so-called drift occurs, which accumulates as an integral error, and it becomes difficult to perform accurate image stabilization.

Accordingly, the second shake detector 102 may detect shakes by combining detection information from another sensor having different noise characteristics, such as an acceleration sensor or a geomagnetic sensor, with gyro-sensor detection information. In general, the acceleration or geomagnetic sensor tends to have less low-frequency noise and more high-frequency noise than those of the gyro sensor. Thus, the shake detection accuracy can be improved by combining the low-frequency component of the acceleration or geomagnetic sensor and the high-frequency component of the gyro sensor using a complementary filter or the like.

In a case where a combined signal is calculated from the low-frequency component of the acceleration or geomagnetic sensor and the high-frequency component of the gyro sensor using a complementary filter or the like, the noise characteristic of the combined signal change according to the cutoff frequency of the low-frequency component and the high-frequency component. In a case where the cutoff frequency is set low, the high-frequency noise of the acceleration or geomagnetic sensor is less likely to be superimposed, but the low-frequency noise of the gyro sensor cannot be sufficiently removed, and the combined signal may have less high-frequency noise and more low-frequency noise. On the other hand, in a case where the cutoff frequency is set high, the high-frequency noise from the acceleration or geomagnetic sensor is likely to be superimposed, but the low-frequency noise from the gyro sensor can be sufficiently removed, and the combined signal may have more high-frequency noise and less low-frequency noise. That is, the lower the cutoff frequency is, the less the high-frequency noise of the combined signal becomes, and the higher the cutoff frequency is, the more the high-frequency noise becomes, but the lower the cutoff frequency is, the more the low-frequency noise becomes, and the more the cutoff frequency is, the less the low-frequency noise becomes. Thus, the low-frequency noise reduction and high-frequency noise superimposition have a trade-off relationship according to the cutoff frequency, and thus it is important to properly set the cutoff frequency.

The angular attitude calculator 103 calculates the angular attitude (orientation) (angular attitude information) of the image pickup apparatus using the second shake signal to find the Euler angles using a known method. The angular attitude calculator 103 can serve as an attitude detector configured to acquire information as to whether the image pickup apparatus is in a horizontal position (normal position) or in a vertical position. The angular attitude may be calculated using the output signal of the LPF 105 described later. The calculated angular attitude information is output to an angle calculation axis determining unit (sensor selector) 104.

The angle calculation axis determining unit 104 determines which of the detection signal of the acceleration sensor and the detection signal of the geomagnetic sensor is to be used for the angular calculation of each rotation axis direction of the pitch, yaw, and roll, based on the angular attitude information. For example, in a case where the image pickup apparatus is in an approximately normal (horizontal) position attitude (in which the Y-axis is parallel to the gravity direction and the X-axis and Z-axis are orthogonal to it), the angles of the pitch and roll axes directions are calculated based on the detection signal of the acceleration sensor, and the angle of the yaw axis direction is calculated based on the detection signal of the geomagnetic sensor. This is because the rotation in the yaw axis direction has no change in gravitational acceleration with respect to the X-axis, Y-axis, and Z-axis, and the angle of the yaw axis direction cannot be calculated based on the detection signal of the acceleration sensor. Alternatively, in a case where the image pickup apparatus is in an approximately vertical position attitude (in which the X-axis is parallel to the gravity direction and the Y-axis and Z-axis are orthogonal to it), the angles of the yaw and roll axes directions are calculated based on the detection signal of the acceleration sensor, and the angle of the pitch axis direction is calculated based on the detection signal of the geomagnetic sensor. This is for similar reasons.

The LPF 105 outputs a signal (second signal), from which high-frequency components have been removed from the second shake signal, to an angle calculator 106. The cutoff frequency of the LPF 105 may be about 1 to 10 Hz, but is not limited to this example.

The angle calculator 106 calculates angles (angular signals) of the pitch, yaw, and roll axes directions according to the combination of each sensor detection signal and each rotation axis direction determined by the angle calculation axis determining unit 104. The calculated angular signal is output to a combined image stabilizing signal calculator 111.

The first image stabilizing signal calculator 107 converts the angular velocity signal, which is the first shake signal, into an angle by integration processing to calculate a first image stabilizing signal, and outputs the first image stabilizing signal to an image stabilizing signal selector 112.

The imaging condition information acquiring unit 108 acquires imaging condition information of the image pickup apparatus and outputs it to a cutoff frequency setting unit 110. The imaging condition information includes at least one of the exposure time, the shutter type of the image pickup apparatus, and the norm of the second shake signal in three mutually orthogonal axial directions described below. The shutter type of the image pickup apparatus generally includes three types: a mechanical shutter type (front-curtain and rear-curtain mechanical shutters), an electronic front-curtain shutter type (an electronic front-curtain shutter and a mechanical rear-curtain curtain shutter), and an electronic shutter (front-curtain and rear-curtain electronic shutters). However, this embodiment is not limited to this example.

A counter 109 counts at least one of the elapsed time from the calculation starting with the LPF 105 and the elapsed time after the mechanical shutter is driven, and notifies the cutoff frequency setting unit 110 of the counted value. The cutoff frequency setting unit 110 sets the cutoff frequency based on the imaging condition information and the counted value, and notifies the combined image stabilizing signal calculator 111 of the cutoff frequency. That is, the cutoff frequency setting unit 110 changes the cutoff frequency in accordance with the imaging condition information.

The combined image stabilizing signal calculator 111 uses a complementary filter to combine a high-frequency component signal (first signal) obtained from the first shake detector 101 and a low-frequency component signal (second signal) obtained from the second shake detector 102 to calculate a combined image stabilizing signal. In this embodiment, the combined image stabilizing signal calculator 111 combines the first signal and the second signal based on the cutoff frequency notified by the cutoff frequency setting unit 110.

The combined image stabilizing signal calculator 111 constitutes at least a part of a complementary filter that combines the first signal and the second signal. The cutoff frequency corresponds to the cutoff frequency of the complementary filter. The complementary filter has an HPF that passes a first signal out of the first shake signal detected by the first shake detector 101, and an LPF that passes a second signal out of the second shake signal detected by the second shake detector 102.

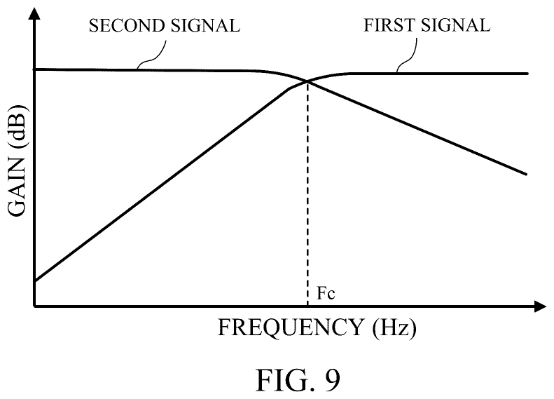

FIG. 9 is a schematic diagram illustrating the frequency characteristics of the complementary filter in this embodiment. In FIG. 9, the vertical axis illustrates the gain (dB) of the complementary filter, and the horizontal axis illustrates the frequency (Hz). The complementary filter has a characteristic of giving an proper gain to each of the first shake signal and the second shake signal according to the frequency (frequency band), and the sum of the gains of the HPF and LPF is 1 in an arbitrary frequency band. In FIG. 9, the frequency at which the gains of the first signal and the second signal are equal (the frequency at which the first signal and the second signal cross) is the cutoff frequency, i.e., the cutoff frequency Fc.

The first signal is a signal of the first shake signal having frequencies higher than the cutoff frequency, and the second signal is a signal of the second shake signal having frequencies lower than the cutoff frequency. However, this embodiment is not limited to this example, and the first signal may be a signal of the first shake signal including a frequency higher than the cutoff frequency, and the second signal may be a signal of the second shake signal including a frequency lower than the cutoff frequency.

The image stabilizing signal selector 112 selects one of the first image stabilizing signal and the combined image stabilizing signal based on the cutoff frequency, and outputs the selected signal (final image stabilizing signal) to an image stabilization drive signal calculator (second calculator) 113.

The image stabilization drive signal calculator 113 performs known calculations, such as multiplying the image stabilizing signal output from the image stabilizing signal selector 112 by a focal length or the driving resolution of an image stabilizing member (correction member) 114. The image stabilization drive signal calculator 113 calculates an image stabilization drive signal for driving the image stabilizing member 114, and outputs the image stabilization drive signal to the image stabilizing member 114. The image stabilizing member 114 performs image stabilization by being driven in accordance with the image stabilization drive signal.

A part of the above units are achieved by a processor such as one or more CPUs loading and executing a program. For example, the angular attitude calculator 103, the angle calculation axis determining unit 104, the angle calculator 106, and the first image stabilizing signal calculator 107 may be implemented by a processor. The imaging condition information acquiring unit 108, the cutoff frequency setting unit 110, the combined image stabilizing signal calculator 111, the image stabilizing signal selector 112, and the image stabilization drive signal calculator 113 may also be implemented by a processor.

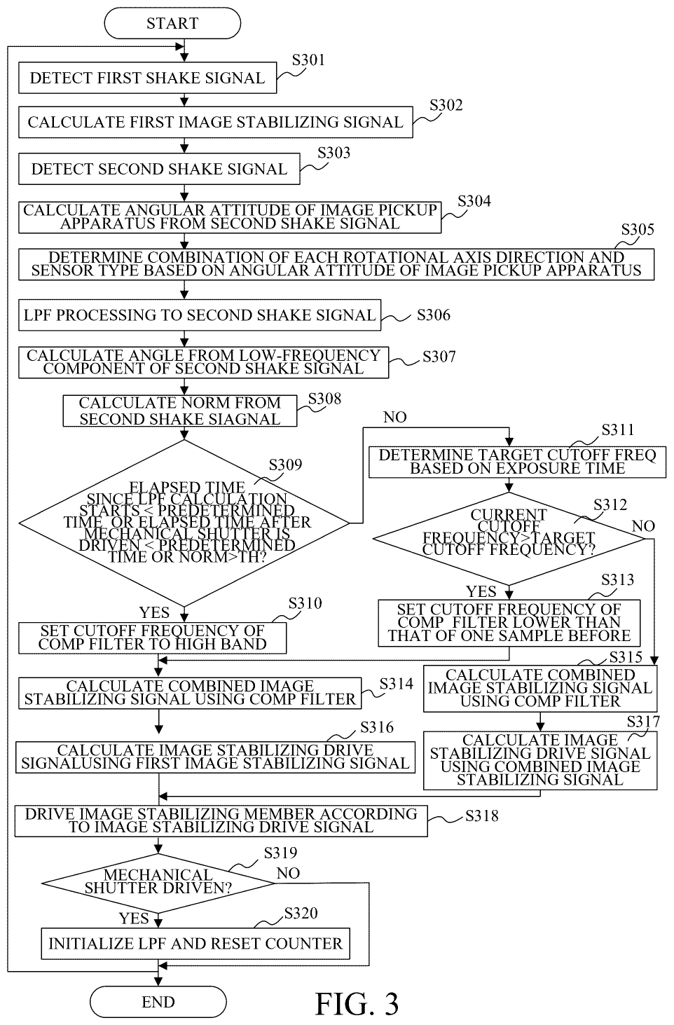

Referring now to FIG. 3, a description will be given of the processing of the image stabilizing apparatus 100 (image stabilization operation and control method of the image stabilizing apparatus 100). FIG. 3 is a flowchart illustrating the processing of the image stabilizing apparatus 100.

“START” in FIG. 3 indicates a start due to a turning-on state, such as powering on the image pickup apparatus or turning on the image stabilizing mode. In the turning-on state, the flow returns to a “START” block without transitioning to a final “END” block, and the flow in FIG. 3 is repeated. The cycle of the series of processing follows the detection cycle of the first shake detector 101 and the second shake detector 102 and the calculation cycle of the complementary filter. The “END” block in FIG. 3 indicates an end due to powering off the image pickup apparatus or turning off the image stabilizing mode.

First, in step S301, the first shake detector 101 detects a first shake signal applied to the image pickup apparatus. Next, in step S302, the first image stabilizing signal calculator 107 converts the first shake signal into an angle by integration processing to calculate the first image stabilizing signal. Next, in step S303, the second shake detector 102 detects the second shake signal applied to the image pickup apparatus. Next, in step S304, the angular attitude calculator 103 calculates the angular attitude of the image pickup apparatus from the second shake signal. Next, in step S305, the angle calculation axis determining unit 104 determines a combination of each rotation axis direction and the type of sensor based on the angular attitude of the image pickup apparatus. Next, in step S306, the LPF 105 removes high-frequency component from the second shake signal.

Next, in step S307, the angle calculator 106 calculates an angle from the low-frequency component of the second shake signal. As an example, the angle calculation in the angular attitude of the image pickup apparatus in an approximately normal attitude will be described. An angle θa_Roll of the roll axis and an angle θa_Pitch of the pitch axis are calculated using the low-frequency components (ax, ay, az) of the three-axis acceleration sensor signal, which is the second shake signal, according to the following equations (1) and (2), respectively.

$${θ}_{a \_ Roll} = {tan}^{- 1} ( \frac{{a}_{x}}{{a}_{y}} ) \qquad ( 1 )$$

$${θ}_{a \_ Pitch} = {tan}^{- 1} \frac{{a}_{z}}{\sqrt{{a}_{x}^{2} + {a}_{y}^{2}}} \qquad ( 2 )$$

An angle θm_Yaw of the yaw axis is calculated using the angle θa_Roll of the roll axis, the angle θa_Pitch of the pitch axis, and the low-frequency components (mx, my, mz) of the three-axis geomagnetic sensor signal, which is the second shake signal, as illustrated in the following equation (3).

$${θ}_{m \_ Yaw} = {tan}^{- 1} \frac{{m}_{z} cos {θ}_{a \_ Pitch} + {m}_{x} sin {θ}_{a \_ Pitch} sin {θ}_{a \_ Roll} + {m}_{y} sin {θ}_{a \_ Pitch} cos {θ}_{a \_ Roll}}{{m}_{x} cos {θ}_{a \_ Roll} - {m}_{y} sin {θ}_{a \_ Roll}} \qquad ( 3 )$$

An angle obtained by integrating the gyro signal is a relative angle from the integration calculation start time, whereas the angles calculated above (θa_Roll, θa_Pitch, θm_Yaw) are absolute angles with respect to the gravity direction and direction, so they are to be converted to relative angles. These absolute angles can be converted into relative angles by subtracting an absolute-angle fixed-value at an arbitrary time from an absolute angle calculated in a time series. The arbitrary time may be, for example, the time when the image pickup apparatus or the image stabilizing apparatus is powered on, or the time when the processing of step S310 or the processing of step S320 is performed.

Next, in step S308, the imaging condition information acquiring unit 108 calculates the norm of the second shake signal from the second shake signal. The norm of the second shake signal is calculated by the following equation (4) using the second shake signal in the three axial directions (X, Y, Z).

$${L}^{2} norm = \sqrt{{X}^{2} + {Y}^{2} + {Z}^{2}} \qquad ( 4 )$$

The second shake signal has a large noise amount in the high-frequency band. Thus, the norm of the second shake signal may be calculated using the low-frequency component of the second shake signal output from the LPF 105.

Next, in step S309, the cutoff frequency setting unit 110 determines whether each of the elapsed time from the calculation starting with the LPF 105 and the elapsed time after the mechanical shutter is driven, counted by the counter 109, has exceeded a predetermined time. The cutoff frequency setting unit 110 also determines whether the norm of the second shake signal has exceeded a threshold value TH. Based on these determination results, the cutoff frequency setting unit 110 sets the cutoff frequency in step S310 and thereafter.

In a case where one of the elapsed time from the calculation starting with the LPF 105 and the elapsed time after the mechanical shutter is driven is less than a predetermined time, or the norm of the second shake signal exceeds the threshold value TH, the flow proceeds to step S310. Otherwise, the flow proceeds to step S311.

The predetermined time corresponding to the elapsed time from the calculation start of the LPF 105 may be approximately the time constant of the LPF 105. This is because the output signal from the LPF 105 contains a transient response and does not provide an accurate output until approximately the time constant has elapsed. The predetermined time corresponding to the elapsed time after the mechanical shutter is driven may be set to the time until the vibration of the image pickup apparatus is sufficiently attenuated by the mechanical shutter drive.

Regarding the threshold value of the norm of the second shake signal, the norm of the acceleration signal is determined based on whether or not the absolute value of a difference from the gravitational acceleration of 1 G is equal to or greater than the threshold value. For example, in a case where the threshold value is set to 0.2 G, it is determined that the norm of the acceleration signal does not exceed the threshold value in a case where it is 0.8 to 1.2 G. The norm of the acceleration signal is significantly different from 1 G, for example, where the user pans the image pickup apparatus widely or it is on a moving body such as a car. In this case, the angle cannot be calculated correctly from the acceleration signal. Similarly, the norm of the geomagnetic sensor can be determined based on whether or not the absolute value of a difference from the norm after the geomagnetic sensor is calibrated by a known method is equal to or greater than the threshold value. In general, in a case where a magnetic body such as iron approaches the geomagnetic sensor, the norm may exceed the threshold value. Since the causes of the change in the norm of the acceleration signal and the norm of the geomagnetic signal are different, independent determination for each sensor may be performed.

In step S310, the cutoff frequency setting unit 110 sets the cutoff frequency (Hz) of the complementary filter to a high frequency. In step S311, the cutoff frequency setting unit 110 sets (determines) a target cutoff frequency based on the exposure time obtained from the imaging condition information acquiring unit 108.

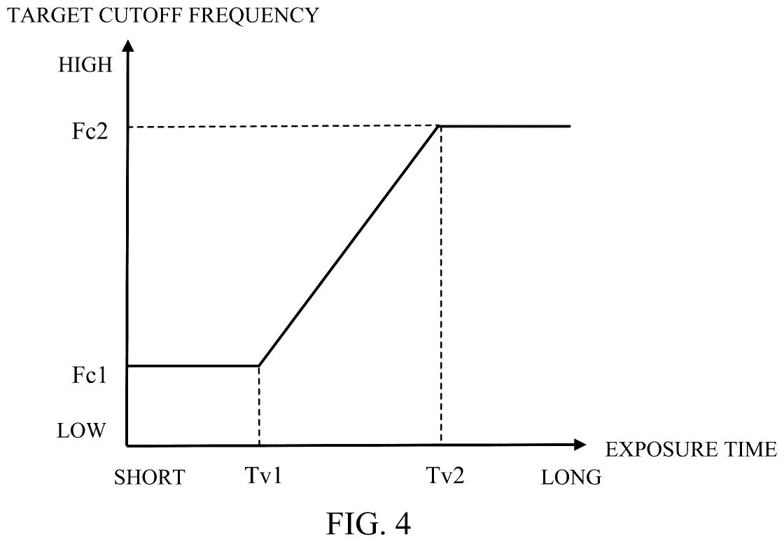

For example, as illustrated in FIG. 4, the exposure time may be associated with the target cutoff frequency. FIG. 4 illustrates a relationship between the target cutoff frequency and the exposure time. In FIG. 4, a horizontal axis (abscissa) represents the exposure time, and a vertical axis (ordinate) represents the target cutoff frequency. This example provides a lower limit Fc1 and an upper limit Fc2 of the target cutoff frequency. Even if the exposure time is short, the target cutoff frequency is set so as not to be lower than the lower limit Fc1. On the other hand, even if the exposure time is long, the target cutoff frequency is set so as not to be higher than the upper limit Fc2. The exposure times Tv1 and Tv2 satisfy a relationship Tv1≤Tv2, and the lower limit Fc1 and the upper limit Fc2 satisfy a relationship Fc1<Fc2. Alternatively, Fc1=0 (Hz) may be used. Fc2 may be determined according to the noise characteristics of the first shake detector 101 and the second shake detector 102, and is, for example, about Fc2=0.005 to 0.5 (Hz).

In this embodiment, the cutoff frequency setting unit 110 sets the cutoff frequency higher as the exposure time is longer, and sets the cutoff frequency lower as the exposure time is shorter. That is, in a case where the exposure time is the first exposure time (Tv1), the cutoff frequency setting unit 110 sets the cutoff frequency to the first frequency (Fc1), and in a case where the exposure time is the second exposure time (Tv2) longer than the first exposure time, the cutoff frequency setting unit 110 sets the cutoff frequency to the second frequency (Fc2) higher than the first frequency. A change in the target cutoff frequency in a case where the exposure time is between the first exposure time and the second exposure time may be linear as illustrated in FIG. 4, or nonlinear.

Next, in step S312, the cutoff frequency setting unit 110 compares the current cutoff frequency that is actually used in the calculation of the complementary filter with the target cutoff frequency, and if the current cutoff frequency is greater than the target cutoff frequency, the flow proceeds to step S313. On the other hand, in a case where the current cutoff frequency is smaller than the target cutoff frequency, the flow proceeds to step S315.

In step S313, the cutoff frequency setting unit 110 sets the cutoff frequency of the complementary filter lower than that of the last sample (one step before). In steps S314 and S315, the combined image stabilizing signal calculator 111 uses the complementary filter to combine the high-frequency component of the first shake signal and the low-frequency component of the second shake signal according to the cutoff frequency using the following equations (5) and (6), thereby calculating a combined image stabilizing signal.

$$K = ( \frac{\frac{1}{2 π {F}_{c}}}{\frac{1}{2 π {F}_{c}} + {T}_{s}} ) \qquad ( 5 )$$

$$θ ( n ) = K ( θ ( n - 1 ) + {T}_{s} {ω}_{g} ( n ) ) + ( 1 - K ) {θ}_{am} ( n ) \qquad ( 6 )$$

Here, θ is the combined image stabilizing signal, F_{C} is the cutoff frequency, K is the complementary filter coefficient, ω_{g} is the first shake signal, θₐₘ is the second shake signal, T_{S} is the sampling time, n is the current sample, and (n−1) is the sample just before the current sample (last sample).

In step S316, the image stabilizing signal selector 112 selects the first image stabilizing signal, and the image stabilization drive signal calculator 113 calculates the image stabilization drive signal using the first image stabilizing signal. In step S317, the image stabilizing signal selector 112 selects the combined image stabilizing signal, and the image stabilization drive signal calculator 113 calculates the image stabilization drive signal using the combined image stabilizing signal.

Then, in step S318, the image stabilizing apparatus 100 drives the image stabilizing member 114 in accordance with the image stabilization drive signal. Then, in step S319, the image stabilizing apparatus 100 determines whether or not the mechanical shutter has been driven by imaging. In a case where the mechanical shutter has been driven, the flow proceeds to step S320. On the other hand, in a case where the mechanical shutter has not been driven, the flow returns to the START block or transitions to the END block to end this flow.

In step S320, the image stabilizing apparatus 100 initializes the LPF 105 and resets the counter 109. The counted value of the counter 109 is used for the conditional branch in step S309. Then, the flow returns to the START block or transitions to the END block to end the flow.

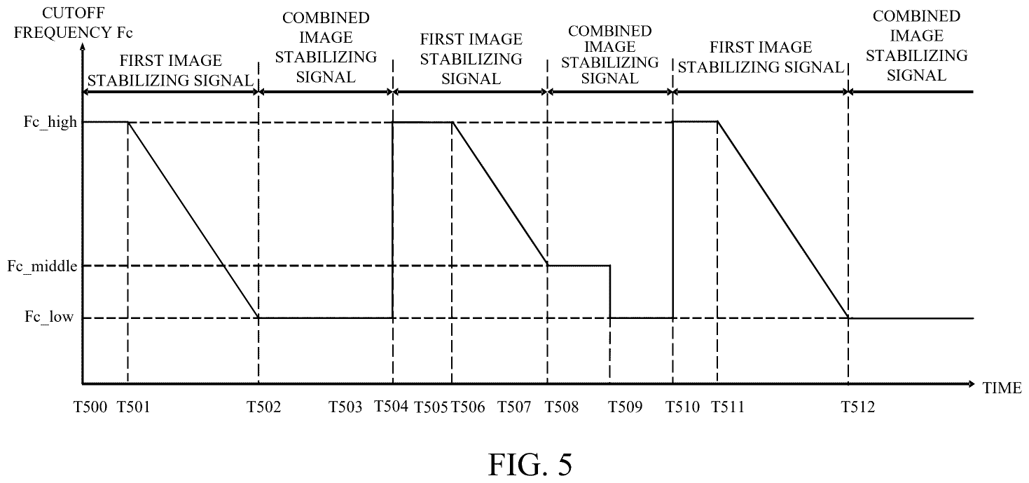

Referring now to FIG. 5, a description will be given of a method for setting a cutoff frequency by the cutoff frequency setting unit 110 and a method for selecting an image stabilizing signal by the image stabilizing signal selector 112. FIG. 5 illustrates the time progression of a cutoff frequency. In FIG. 5, the vertical axis represents the cutoff frequency, and the horizontal axis represents time. Here, it is assumed that the norm of the second shake signal does not exceed the threshold value except just after the mechanical rear-curtain shutter is driven by the electronic front-curtain shutter type and at time T510.

Time T500 is the time when the image stabilizing mode is turned on and the series of calculations in the flowchart of FIG. 3 are started. At the same time, the counter 109 starts counting. In the conditional branch in step S309, the elapsed time from the calculation starting with the LPF 105 is less than a predetermined time. Therefore, the flow proceeds to step S310, where the cutoff frequency Fc is set to a high cutoff frequency Fc_high. In step S314, a combined image stabilizing signal is calculated by the complementary filter based on the cutoff frequency Fc_high.

A period from time T500 to time T501 is a period for waiting for stabilization of the transient response of the LPF 105, and during this period the cutoff frequency is set to Fc_high. However, the cutoff frequency does not need to be fixed, and may be gradually lowered from this period, for example.

At time T501, the elapsed time from the calculation starting with the LPF 105 exceeds a predetermined time, so the flow moves from the conditional branch in step S309 to step S311, and the target cutoff frequency is determined to be a low Fc_low based on the set exposure time Tv_long (not illustrated).

During a period from time T501 to time T502, the current cutoff frequency Fc is greater than the target cutoff frequency Fc_low according to the conditional branch of step S312, so the flow proceeds to step S313, where the cutoff frequency Fc is lowered for each sample than the previous sample. The cutoff frequency may be lowered linearly as illustrated in FIG. 5, or may be lowered nonlinearly. Then, in step S314, a combined image stabilizing signal is calculated by the complementary filter based on the current cutoff frequency Fc. By providing a period during which the cutoff frequency is gradually lowered, the transient response period of the complementary filter can be reduced. That is, just after the combined image stabilizing signal calculator 111 starts generating the combined image stabilizing signal, the cutoff frequency setting unit 110 sets the cutoff frequency to a predetermined high cutoff frequency. Then, the cutoff frequency setting unit 110 lowers the cutoff frequency over time to a predetermined low cutoff frequency.

At time T502, the cutoff frequency Fc becomes the target cutoff frequency Fc_low, and the flow moves from the conditional branch of step S312 to step S315, where a combined image stabilizing signal is calculated by the complementary filter based on the cutoff frequency Fc_low. At time T503, assume that the electronic front-curtain shutter is driven to start exposure. Since it is not a mechanical shutter, the cutoff frequency is not increased. If the mechanical front-curtain shutter had been driven to start exposure at time T503, the cutoff frequency Fc would be set to Fc_high from time T503.

At time T504, since the mechanical rear-curtain shutter is driven, the cutoff frequency Fc is set to Fc_high. At the same time, in accordance with the conditional branch of step S319, the proceeds to step S320, where the LPF 105 is initialized and the counter 109 is reset. If the electronic shutter type is set and exposure is started at time T504 by driving the electronic rear-curtain shutter instead of the mechanical rear-curtain shutter, the cutoff frequency is not increased but remains at Fc low at time T504.

At time T505, the time elapsed from the calculation starting with the LPF 105 exceeds a predetermined time, but the time elapsed since the mechanical shutter was driven is still less than the predetermined time, so the cutoff frequency Fc remains at Fc_high.

At time T506, the elapsed time since the mechanical shutter is driven exceeds the predetermined time, so the flow moves from the conditional branch of step S309 to step S311, and the target cutoff frequency is determined to be Fc_Low based on the set exposure time Tv_long. This example sets the predetermined time for determining the elapsed time after the mechanical shutter was driven, longer than the predetermined time for determining the elapsed time from the calculation starting with the LPF 105, but this embodiment is not limited to this example. If the image pickup apparatus has a mechanical shutter that requires time for vibration attenuation, or if the time constant of the LPF is set long, the relationship between the lengths of the predetermined times will be reversed.

That is, in a case where the shutter type is a mechanical shutter type, the cutoff frequency setting unit 110 sets the cutoff frequency higher than that in the case of the electronic shutter type until a predetermined time has elapsed after the mechanical shutter is driven. In a case where the shutter type is an electronic front-curtain shutter type, the cutoff frequency setting unit 110 sets the cutoff frequency higher than that until a predetermined time has elapsed after the mechanical rear-curtain shutter is driven, after the predetermined time has elapsed, or in a case where the shutter type is the electronic shutter type. After the predetermined time has elapsed, the cutoff frequency setting unit 110 lowers the cutoff frequency over time to a predetermined low cutoff frequency.

At time T507, the exposure time is set to Tv_short, which is shorter than Tv_long, and in step S311 for that sample, the target cutoff frequency is determined to be Fc_middle, which is higher than Fc_Low.

During a period from time T506 to time T508, similarly to a period from time T501 to time T502, the current cutoff frequency Fc is greater than the target cutoff frequency Fc_middle according to the conditional branch of step S312, so the flow proceeds to step S313. Then, the cutoff frequency Fc of each sample becomes lower than the cutoff frequency of the sample just before each sample. Then, in step S314, a combined image stabilizing signal is calculated by the complementary filter based on the current cutoff frequency Fc.

At time T508, the cutoff frequency Fc becomes the target cutoff frequency Fc_middle, and the flow moves from the conditional branch of step S312 to step S315, where a combined image stabilizing signal is calculated by the complementary filter based on the cutoff frequency Fc_middle.

At time T509, the set exposure time is returned from Tv_short to Tv_long, and in step S311, the target cutoff frequency is determined to be Fc_low. Then, the flow proceeds to step S313 from the conditional branch of step S312, where the cutoff frequency is lowered to Fc_low. The flow proceeds to step S315 from the conditional branch of step S312 for the next sample, where a combined image stabilizing signal is calculated by the complementary filter based on the cutoff frequency Fc_low.

At time T510, the norm of the second shake signal momentarily exceeds the threshold value (predetermined value) due to an object hitting the image pickup apparatus, etc., so the flow moves from the conditional branch of step S309 to step S310, and the cutoff frequency is set to Fc_high. By setting the cutoff frequency high once, the transient response of the complementary filter is reduced. That is, in a case where the norm of the second shake signal is equal to or greater than the predetermined value, the cutoff frequency setting unit 110 sets the cutoff frequency higher than that in a case where the norm is smaller than the predetermined value. In a case where the norm transitions from a value equal to or greater than the predetermined value to a value smaller than the predetermined value, the cutoff frequency setting unit 110 lowers the cutoff frequency over time to a predetermined low cutoff frequency.

A period from time T510 to time T511 is similar to a period from time T500 to time T501, and a period from time T511 to time T512 is similar to a period from time T501 to time T502, and thus a description thereof will be omitted.

The image stabilizing signal selector 112 selects the combined image stabilizing signal in a case where the cutoff frequency Fc is the target cutoff frequency, that is, in a case where the flow moves from the conditional branch in step S312 to step S315. On the other hand, in other cases, the image stabilizing signal selector 112 selects the first image stabilizing signal. Therefore, in FIG. 5, the first image stabilizing signal is selected during the period from time T500 to time T502, the period from time T504 to time T508, and the period from time T510 to time T512. The combined image stabilizing signal is selected during the period from time T502 to time T504, the period from time T508 to time T510, and the period from time T512 on.

This embodiment can set a proper cutoff frequency, in the combination of the acceleration or geomagnetic sensor and the gyro sensor using the complementary filter, based on the exposure time, shutter type, and norm of the acceleration or geomagnetic sensor. In addition, this embodiment can perform accurate image stabilization by properly selecting and switching between an image stabilizing signal calculated only by the gyro sensor and a combined image stabilizing signal calculated by the complementary filter.

### Second Embodiment

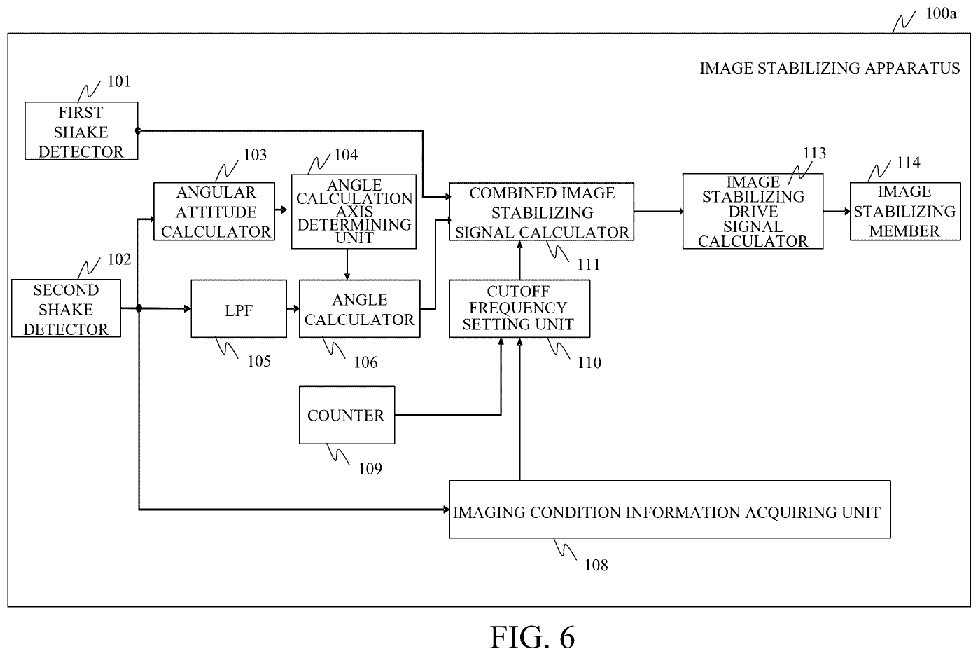

Next, a second embodiment of the present disclosure will be described. In the first embodiment, the image stabilizing signal selector 112 selects one of the first image stabilizing signal and the combined image stabilizing signal to calculate the image stabilization drive signal. However, in a case where the combined image stabilizing signal calculator 111 generates a combined image stabilizing signal using a complementary filter with a cutoff frequency of 0 Hz, it becomes equivalent to the first image stabilizing signal. Therefore, as illustrated in FIG. 6, an image stabilizing apparatus 100a according to this embodiment has a configuration in which the first image stabilizing signal calculator 107 and the image stabilizing signal selector 112 are excluded from the image stabilizing apparatus 100 of FIG. 1. FIG. 6 is a block diagram of the image stabilizing apparatus 100a according to this embodiment. Each component illustrated in FIG. 6 is common to the first embodiment, and thus a description thereof will be omitted.

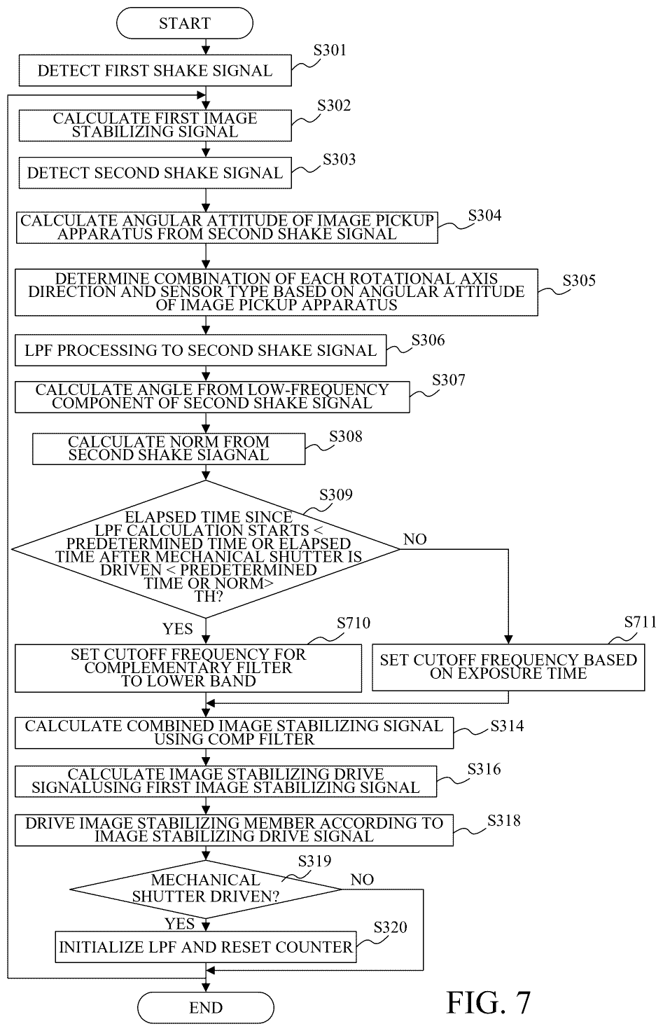

Referring now to FIG. 7, the processing of the image stabilizing apparatus 100a (image stabilizing operation, control method of the image stabilizing apparatus 100a) will be described. FIG. 7 is a flowchart illustrating the processing of the image stabilizing apparatus 100a. In FIG. 7, the same reference numerals are used for steps common to those in FIG. 3, and a description thereof will be omitted.

In step S710, the cutoff frequency setting unit 110 sets the cutoff frequency of the complementary filter to a low frequency. At this time, the cutoff frequency may be set to approximately 0 (Hz). In step S711, the cutoff frequency setting unit 110 sets a target cutoff frequency based on the exposure time obtained from the imaging condition information acquiring unit 108.

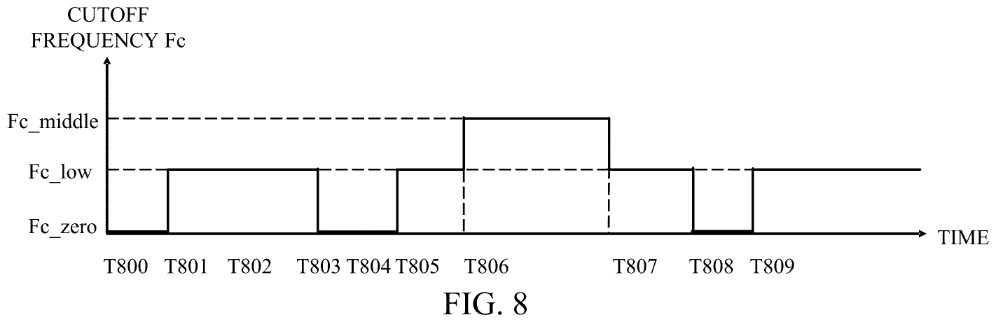

A method for setting a cutoff frequency by the cutoff frequency setting unit 110 will now be described with reference to FIG. 8. FIG. 8 illustrates the time progression of the cutoff frequency in this embodiment. In FIG. 8, the vertical axis indicates the cutoff frequency, and the horizontal axis indicates time.

Time T800 is the time when the image stabilizing mode is turned on and the series of calculations in the flowchart in FIG. 7 are started. At the same time, the counter 109 starts counting. In the conditional branch of step S309, the elapsed time from the calculation starting with the LPF 105 is less than a predetermined time. Therefore, the flow proceeds to step S710, where the cutoff frequency is set to an extremely low cutoff frequency Fc_zero. In step S314, a combined image stabilizing signal is calculated by the complementary filter based on the cutoff frequency Fc_zero.

A period from time T800 to time T801 is a period for waiting for stabilization of the transient response of LPF 105, and during this period the cutoff frequency is set to Fc_zero.

At time T801, the elapsed time from the calculation starting with the LPF 105 exceeds a predetermined time, so the flow moves from the conditional branch in step S309 to step S711, where the cutoff frequency is set to a low cutoff frequency Fc_low based on the set exposure time Tv_long (not illustrated).

At time T802, assume that the electronic front-curtain shutter is driven to start exposure. Since it is not a mechanical shutter, the cutoff frequency is not lowered. If the mechanical front-curtain shutter were driven to start exposure at time T802, the cutoff frequency Fc would be set to Fc_zero from time T802. That is, in a case where the shutter type is the mechanical shutter type, the cutoff frequency setting unit 110 sets the cutoff frequency lower than that in the case of the electronic shutter type until the predetermined time has elapsed after the mechanical shutter is driven. In a case where the shutter type is the electronic front-curtain shutter type, the cutoff frequency setting unit 110 sets the cutoff frequency lower than that until the predetermined time has elapsed after the mechanical rear-curtain shutter is driven, after the predetermined time has elapsed, or in a case where the shutter type is the electronic shutter type.

At time T803, since the mechanical rear-curtain shutter is driven, the cutoff frequency Fc is set to Fc_zero. At the same time, the flow moves from the conditional branch of step S319 to step S320, where the LPF 105 is initialized and the counter 109 is reset. If the electronic shutter type is set and exposure is started at time T803 by driving the electronic rear-curtain shutter instead of the mechanical rear-curtain shutter, the cutoff frequency is so low that it is not set to Fc_zero but remains at Fc_low at time T803.

At time T804, the elapsed time from the calculation starting with the LPF 105 exceeds a predetermined time, but the time that has elapsed since the mechanical shutter was driven is still less than the predetermined time, so the cutoff frequency Fc remains at Fc_zero. At time T805, the time that has elapsed since the mechanical shutter was driven exceeds the predetermined time, so the flow moves from the conditional branch in step S309 to step S711, where the cutoff frequency is set to Fc_Low based on the set exposure time Tv_long.

At time T806, the exposure time is set to Tv_short, which is shorter than Tv_long, and in step S711 for that sample, the cutoff frequency is set to Fc_middle, which is higher than Fc_Low. At time T807, the set exposure time is returned from Tv_short to Tv_long, and in step S711 the cutoff frequency is set to Fc_low.

At time T808, the norm of the second shake signal momentarily exceeds the threshold value (predetermined value) due to an object hitting the image pickup apparatus, etc., the flow moves from the conditional branch of step S309 to step S310, and the cutoff frequency is set to Fc_zero. That is, in a case where the norm of the second shake signal is equal to or greater than the predetermined value, the cutoff frequency setting unit 110 sets the cutoff frequency lower than that in a case where the norm is smaller than the predetermined value.

At time T809, the elapsed time from the calculation starting with the LPF 105 exceeds the predetermined time, so the flow moves from the conditional branch of step S309 to step S711, where the cutoff frequency is set to a low Fc_low based on the set exposure time Tv_long.

This embodiment can set a proper cutoff frequency, in the combination of the acceleration or geomagnetic sensor and gyro sensor using the complementary filter, based on the exposure time, shutter type, and norm of the acceleration or geomagnetic sensor.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

Each embodiment can set a proper cutoff frequency, in the combination of the acceleration or geomagnetic sensor and the gyro sensor using the complementary filter, based on the imaging condition information, so that the offset component of the gyro sensor can be removed. Therefore, each embodiment can provide an image stabilizing apparatus, its control method, an optical apparatus, and a storage medium, each of which can perform image stabilization with high accuracy.

While the disclosure has described example embodiments, it is to be understood that the disclosure is not limited to the example embodiments. The scope of the following claims is to be accorded the broadest interpretation so as to encompass all such modifications and equivalent structures and functions. For example, in each embodiment, the imaging condition information includes information on at least one of an exposure time, a shutter type of an image pickup apparatus, and a norm of the second shake signal, but each embodiment is not limited to this example. The imaging condition information may be imaging condition information that affects detection of at least one of the first sensor and the second sensor.

This application claims priority to Japanese Patent Application No. 2024-085255, which was filed on May 27, 2024, and which is hereby incorporated by reference herein in its entirety.

What is claimed is:

1. An image stabilizing apparatus comprising:
a first acquiring unit configured to acquire a first shake signal using a first sensor;
a second acquiring unit configured to acquire a second shake signal having a larger noise amount in a high-frequency band and a smaller noise amount in a low-frequency band than those of the first shake signal, using a second sensor; and
at least one processor that executes instructions to:
generate a combined image stabilizing signal based on a first signal of the first shake signal, which first signal has a frequency higher than a cutoff frequency and a second signal of the second shake signal, which second signal has a frequency lower than the cutoff frequency,
set the cutoff frequency, and
change the cutoff frequency according to imaging condition information.

2. The image stabilizing apparatus according to claim 1, wherein the imaging condition information is imaging condition information that affects detection of at least one of the first sensor and the second sensor.

3. The image stabilizing apparatus according to claim 1, wherein the imaging condition information includes information on at least one of an exposure time, a shutter type of an image pickup apparatus, and a norm of the second shake signal.

4. The image stabilizing apparatus according to claim 1, wherein the imaging condition information is information on an exposure time, and
wherein the processor is configured to:
set the cutoff frequency to a first frequency in a case where the exposure time is a first exposure time, and
set the cutoff frequency to a second frequency higher than the first frequency in a case where the exposure time is a second exposure time longer than the first exposure time.

5. The image stabilizing apparatus according to claim 1, wherein the imaging condition information is information on a norm of the second shake signal, and
wherein the processor is configured to set the cutoff frequency lower in a case where the norm is equal to or greater than a predetermined value than the cutoff frequency in a case where the norm is less than the predetermined value.

6. The image stabilizing apparatus according to claim 1, wherein the imaging condition information is information on a shutter type of an image pickup apparatus, and
wherein the processor is configured to set the cutoff frequency lower in a case where the shutter type is a mechanical shutter type than the cutoff frequency until a predetermined time has elapsed after a mechanical shutter is driven in a case where the shutter type is an electronic shutter type.

7. The image stabilizing apparatus according to claim 1, wherein the imaging condition information is information on a shutter type of an image pickup apparatus, and
wherein the processor is configured to set the cutoff frequency lower in a case where the shutter type is an electronic front-curtain shutter type than the cutoff frequency until a predetermined time has elapsed after a mechanical rear-curtain shutter is driven, after the predetermined time has elapsed, or in a case where the shutter type is an electronic shutter type.

8. The image stabilizing apparatus according to claim 1, wherein the processor is configured to:
calculate a first image stabilizing signal based on the first shake signal,
select and output one of the first image stabilizing signal and the combined image stabilizing signal based on the cutoff frequency, and
calculate a drive signal for a correction member for performing image stabilization based on a selected image stabilizing signal.

9. The image stabilizing apparatus according to claim 8, wherein the imaging condition information is information on a norm of the second shake signal, and
wherein the processor is configured to:
set the cutoff frequency high in a case where the norm is equal to or greater than a predetermined value than the cutoff frequency in a case where the norm is less than the predetermined value, and
lower the cutoff frequency over time in a case where the norm transitions from a value equal to or greater than the predetermined value to a value lower than the predetermined value, and set the cutoff frequency to a predetermined low cutoff frequency.

10. The image stabilizing apparatus according to claim 8, wherein the imaging condition information is information on a shutter type of an image pickup apparatus, and
wherein the processor is configured to:
set the cutoff frequency higher in a case where the shutter type is a mechanical shutter type than the cutoff frequency in a case where the shutter type is an electronic shutter until a predetermined time has elapsed after a mechanical shutter is driven, and
lower the cutoff frequency over time after the predetermined time has elapsed, and set the cutoff frequency to a predetermined low cutoff frequency.

11. The image stabilizing apparatus according to claim 8, wherein the imaging condition information is information on a shutter type of an image pickup apparatus, and
wherein the processor is configured to:
set the cutoff frequency higher in a case where the shutter type is an electronic front-curtain shutter type than the cutoff frequency until a predetermined time has elapsed after a mechanical rear-curtain shutter is driven, after the predetermined time has elapsed, or in a case where the shutter type is an electronic shutter type, and
lower the cutoff frequency over time after the predetermined time has elapsed and set the cutoff frequency to a predetermined low cutoff frequency.

12. The image stabilizing apparatus according to claim 8, wherein the processor is configured to:
set the cutoff frequency to a predetermined high cutoff frequency just after the processor starts generating the combined image stabilizing signal, and
lower the cutoff frequency over time to a predetermined low cutoff frequency.

13. The image stabilizing apparatus according to claim 1, wherein the first sensor is a gyro sensor.

14. The image stabilizing apparatus according to claim 1, wherein the second sensor is at least one of an acceleration sensor and a geomagnetic sensor.

15. The image stabilizing apparatus according to claim 1, wherein the processor constitutes at least a part of a complementary filter configured to combine the first signal and the second signal, and
wherein the cutoff frequency is a cutoff frequency of the complementary filter.

16. An optical apparatus comprising:
the image stabilizing apparatus according to claim 1.

17. A control method for an image stabilizing apparatus, the control method comprising:
acquiring a first shake signal;
acquiring a second shake signal having a larger noise amount in a high-frequency band and a smaller noise amount in a low-frequency band than those of the first shake signal;
generating a combined image stabilizing signal based on a first signal of the first shake signal, which first signal has a frequency higher than a cutoff frequency and a second signal of the second shake signal, which second signal has a frequency lower than the cutoff frequency;
setting the cutoff frequency; and
changing the cutoff frequency according to imaging condition information.

18. A non-transitory computer-readable storage medium storing a program that causes a computer to execute the control method according to claim 17.
